(19) United States
(12) Patent Application Publication
(10) Pub. No.: US 2024/0054572 A1
(43) Pub. Date: Feb. 15, 2024

(54) SYSTEM AND METHOD TO PROVIDE FEEDBACK FOR DELIVERED CONTENT

(71) Applicant: YAHOO ASSETS LLC, Dulles, VA (US)

(72) Inventors: Mohit GOENKA, Santa Clara, CA (US); Nikita VARMA, Milpitas, CA (US); Ashish Khushal DHARAMSHI, Sunnyvale, CA (US); Gnanavel SHANMUGAM, San Jose, CA (US)

(21) Appl. No.: 17/818,788

(22) Filed: Aug. 10, 2022

(51) Int. Cl. G06Q 50/00; G06F 40/295; G06F 40/166; H04L 51/18

(52) U.S. Cl. CPC G06Q 50/01; G06F 40/295; G06F 40/166; H04L 51/18

(57) ABSTRACT

In some aspects, the techniques described herein relate to a method including: identifying, by a processor, an object included in a message addressed to a user; inserting, by the processor, an explicit feedback control in the message, the explicit feedback control associated with the object; delivering, by the processor, the message including the explicit feedback control to a client device of the user; and receiving, by the processor, feedback from the user in response to an interaction of the user with the explicit feedback control.

### BACKGROUND

Many network services (e.g., email, instant messaging, social media) transmit messaging content for display on user devices. Currently, senders and network services both rely on implicit feedback (e.g., read receipts, impressions) to gauge the effectiveness and utility of content in such messages. However, such mechanisms are inherently passive in nature and fail to provide accurate feedback from recipients regarding how effective, or useful content in messages is.

### BRIEF DESCRIPTION OF THE DRAWINGS

FIGS. 1A through 1C are block diagrams of messages including feedback controls.

FIG. 2 is a block diagram illustrating a system for utilizing explicit feedback controls in a message service.

FIG. 3 is a flow diagram illustrating a method for augmenting a message with feedback controls.

FIG. 4 is a flow diagram illustrating a method for receiving explicit feedback for messages and processing such feedback.

FIG. 5 is a flow diagram illustrating a method for using explicit feedback to provide messaging suggestions to a sender.

FIG. 6 is a flow diagram illustrating a method for using explicit feedback to filter messages destined for a recipient.

FIG. 7 is a block diagram of a computing device.

### DETAILED DESCRIPTION

The disclosure solves these and other problems in the art of computerized messaging systems by providing in-message explicit feedback controls. A message service analyzes messages to automatically identify concepts or objects that are amenable to feedback. The message service then automatically inserts an explicit feedback control that allows a user to provide explicit feedback on individual concepts or the message as a whole. The message service can then use this feedback to build a model of the user's interests, which can be used to provide suggested edits to future messages or to filter messages prior to delivery.

In some aspects, the techniques described herein relate to a method including: identifying, by a processor, an object included in a message addressed to a user; inserting, by the processor, an explicit feedback control in the message, the explicit feedback control associated with the object; transmitting, by the processor, the message including the explicit feedback control to a client device of the user; and receiving, by the processor, feedback from the user in response to an interaction of the user with the explicit feedback control.

In some aspects, the techniques described herein relate to a method, wherein the object includes one of text, audio, video, or graphical content.

In some aspects, the techniques described herein relate to a method, wherein identifying an object included in a message includes identifying the object using a named entity recognition (NER) routine.

In some aspects, the techniques described herein relate to a method, wherein the explicit feedback control includes a positive feedback control button and a negative feedback control button.

In some aspects, the techniques described herein relate to a method, further including updating a feedback model based on the feedback from the user, the feedback model storing preferences of the user with respect to objects identified in messages addressed to the user.

In some aspects, the techniques described herein relate to a method, further including updating the explicit feedback control based on previous feedback of the user with respect to the object, the previous feedback stored in the feedback model.

In some aspects, the techniques described herein relate to a method, further including: receiving, by the processor, a second message from a sender, the second message received prior to delivery to the user; identifying, by the processor, a second object included in the second message addressed to a user; reading, by the processor, a user preference for the second object using the feedback model; and providing, by the processor, at least one suggestion regarding how to edit the second message to the sender.

In some aspects, the techniques described herein relate to a method, further including: receiving, by the processor, a third message addressed to a user; identifying, by the processor, a third object included in the third message; reading, by the processor, a user preference for the third object using the feedback model; and filtering, by the processor, the third message based on the user preference.

In some aspects, the techniques described herein relate to a non-transitory computer-readable storage medium for tangibly storing computer program instructions capable of being executed by a computer processor, the computer program instructions defining steps of: identifying an object included in a message addressed to a user; inserting an explicit feedback control in the message, the explicit feedback control associated with the object; transmitting the message including the explicit feedback control to a client device of the user; and receiving feedback from the user in response to an interaction of the user with the explicit feedback control.

In some aspects, the techniques described herein relate to a non-transitory computer-readable storage medium, wherein identifying an object included in a message includes identifying the object using a named entity recognition (NER) routine.

In some aspects, the techniques described herein relate to a non-transitory computer-readable storage medium, wherein the explicit feedback control includes a positive feedback control button and a negative feedback control button.

In some aspects, the techniques described herein relate to a non-transitory computer-readable storage medium, the steps further including updating a feedback model based on the feedback from the user, the feedback model storing preferences of the user with respect to objects identified in messages addressed to the user.

In some aspects, the techniques described herein relate to a non-transitory computer-readable storage medium, the steps further including updating the explicit feedback control based on previous feedback of the user with respect to the object, the previous feedback stored in the feedback model.

In some aspects, the techniques described herein relate to a non-transitory computer-readable storage medium, the steps further including: receiving a second message from a sender, the second message received prior to delivery to the user; identifying a second object included in the second message addressed to a user; reading a user preference for the second object using the feedback model; and providing at least one suggestion regarding how to edit the second message to the sender.

In some aspects, the techniques described herein relate to a non-transitory computer-readable storage medium, the steps further including: receiving a third message addressed to a user; identifying a third object included in the third message; reading a user preference for the third object using the feedback model; and filtering the third message based on the user preference.

In some aspects, the techniques described herein relate to a device including: a processor; and a storage medium for tangibly storing thereon logic for execution by the processor, the logic including instructions for identifying an object included in a message addressed to a user; inserting an explicit feedback control in the message, the explicit feedback control associated with the object; transmitting the message including the explicit feedback control to a client device of the user; and receiving feedback from the user in response to an interaction of the user with the explicit feedback control.

In some aspects, the techniques described herein relate to a device, the instructions further including updating a feedback model based on the feedback from the user, the feedback model storing preferences of the user with respect to objects identified in messages addressed to the user.

In some aspects, the techniques described herein relate to a device, the instructions further including updating the explicit feedback control based on previous feedback of the user with respect to the object, the previous feedback stored in the feedback model.

In some aspects, the techniques described herein relate to a device, the instructions further including: receiving a second message from a sender, the second message received prior to delivery to the user; identifying, by the processor, a second object included in the second message addressed to a user; reading, by the processor, a user preference for the second object using the feedback model; and providing, by the processor, at least one suggestion regarding how to edit the second message to the sender.

In some aspects, the techniques described herein relate to a device, the instructions further including: receiving, by the processor, a third message addressed to a user; identifying, by the processor, a third object included in the third message; reading, by the processor, a user preference for the third object using the feedback model; and filtering, by the processor, the third message based on the user preference.

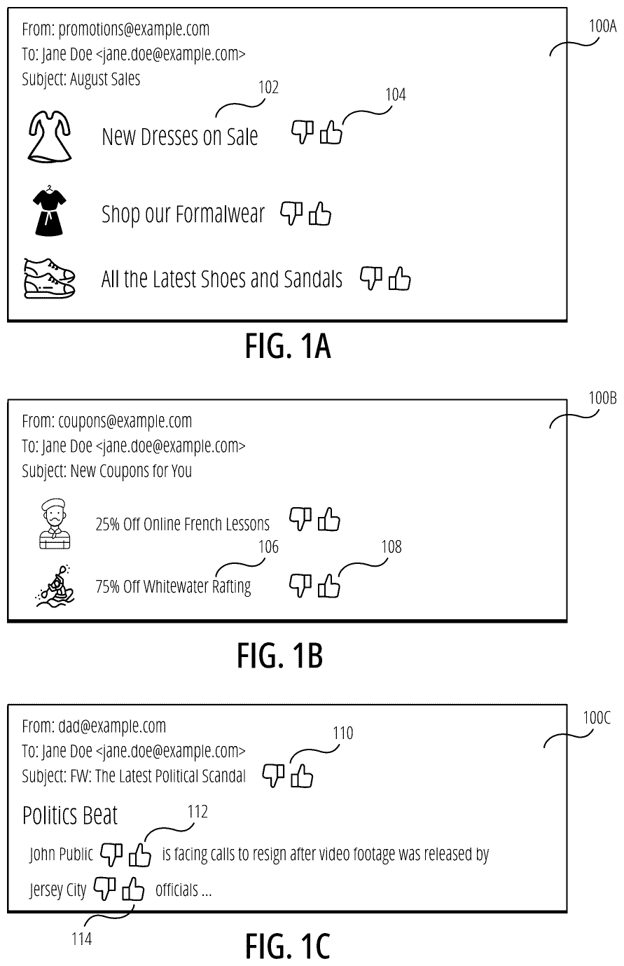

FIGS. 1A through 1C are block diagrams of messages including feedback controls.

FIG. 1A depicts a first message 100A. First message 100A may be an email message from a sender (“promotions@example.com”) to a recipient (“jane.doe@example.com”). As illustrated, the message can include metadata (e.g., a subject) as well as content or a body. In an implementation, the original or raw message may include various content items such as images, audio, video, etc. For example, the content items can include a text hyperlink 102 (“New Dresses on Sale”) and an icon. As illustrated, no limit is placed on the type and amount of content.

As will be discussed, a message service can augment the first message 100A with one or more explicit feedback controls (also referred to as simply feedback controls). For example, the system can automatically identify text hyperlink 102 as an object within first message 100A and insert explicit feedback control 104. In one implementation, the explicit feedback control 104 can take the form of a “thumbs up” and “thumbs down” icon. Such icons can represent positive feedback controls (thumbs up) and negative feedback controls (thumbs down). Explicit feedback control 104 can include hyperlinks or similar types of interactive controls that cause the transmission of network messages back to the systems. For example, explicit feedback control 104 can include a hyperlink to a designated endpoint that enables the transmission of feedback from the client to the system. As another example, explicit feedback control 104 can include JavaScript or other code to issue network requests to the system that include the appropriate feedback to the system. Although positive and negative controls are illustrated, the disclosure is not limited as such, and other types of controls may be used. For example, a continuous slider can be used to provide feedback over a range of values (e.g., zero to ten). Alternatively, only a positive feedback control may be used.

In first message 100A, the explicit feedback control 104 allows a user to express a preference on a per-item basis (e.g., a preference for dresses and not shoes). As will be discussed, this feedback can be associated with the user in a feedback database and used by downstream applications.

FIG. 1B depicts a second message 100B, similar to the first message 100A. In this second message 100B, various coupons are depicted, including a first coupon (“25% Off Online French Lessons”) and a second coupon (“75% Off Whitewater Rafting”). Similar to first message 100A, the content items (coupons) are augmented with explicit feedback controls (e.g., explicit feedback control 108). In some implementations, the objects (e.g., text hyperlink 106) may be associated with properties (e.g., a discount level of 75%). When a user interacts with explicit feedback control 108, this feedback can be associated with such properties of the object. Thus, as described in connection with first message 100A, a feedback database can store not only user preferences for objects but also user preferences for properties of such objects.

While the foregoing examples (e.g., first message 100A and second message 100B) are related to commercial messages, the same principles can be applied to any type of message.

FIG. 1C depicts a third message 100C that is a personal message send from a sender (“dad@example.com”) to a receiver (“jane.doe@example.com”). In this example, the third message 100C comprises a personal message between two parties.

In some implementations, the third message 100C can be augmented similarly to first message 100A and second message 100B. However, various additional augmentations are illustrated.

First, the third message 100C can include a message-level feedback control 110 which operates in a similar manner to explicit feedback control 104 and explicit feedback control 108. However, the message-level feedback control 110 can be associated with the entire message. In some implementations, the system can categorize a message into topics based on the entirety of the message. The message-level feedback control 110 can then be used to provide feedback on these identified concepts. For example, third message 100C may be categorized as “politics” and the message-level feedback control 110 can express a user's preference for political content.

Second, third message 100C can include an inline feedback control 112. In some implementations, the content of the message can be processed (e.g., using named entity recognition, NER) to identify objects within the body content of messages. Here, as an example, the entity (person) of “John Public” was identified and the system inserted inline feedback control 112 next to the instance of the object to allow for quick feedback regarding this object. Similarly, the place “Jersey City” was identified as a named entity and inline feedback control 114 was inserted next to this term to allow for similar feedback. Certainly, more or fewer such entities can be identified and augmented in such a manner.

Systems, devices, computer-readable media, and methods for generating and responding to the above augmented messages are now described in more detail below with respect to the remaining figures.

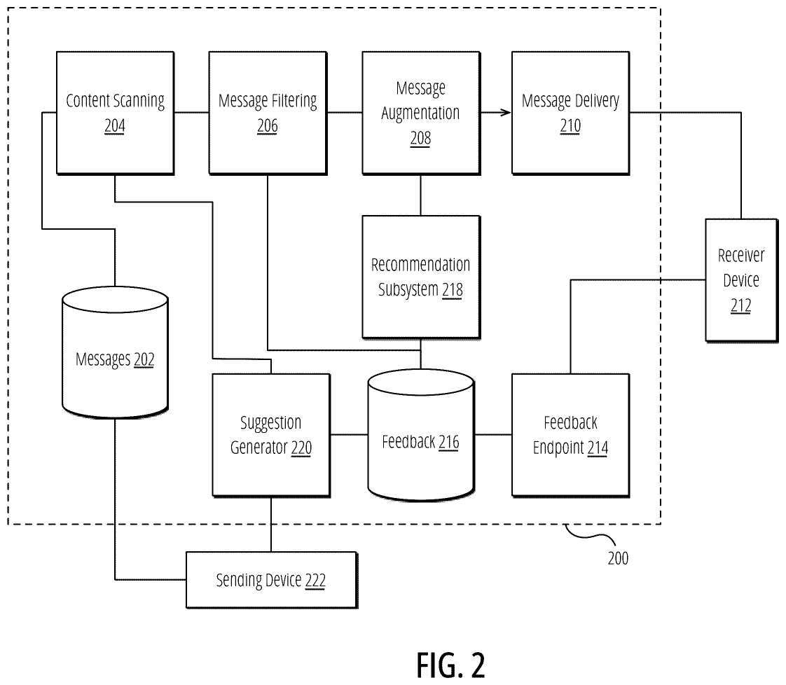

FIG. 2 is a block diagram illustrating a system for utilizing explicit feedback controls in a message service.

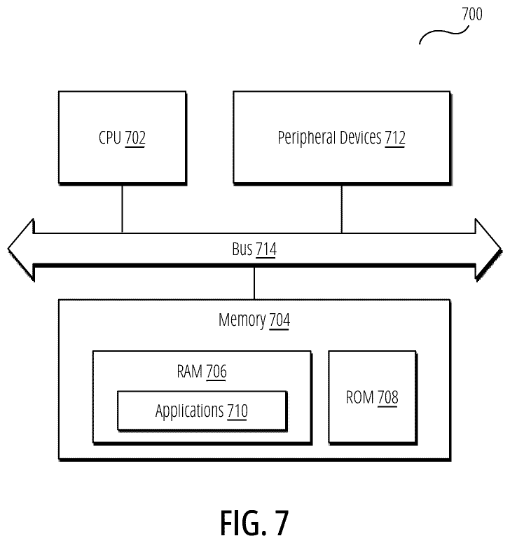

In the illustrated system, a sending device 222 and receiver device 212 communicate over a network (not illustrated) with a message service 200. Both sending device 222 and receiver device 212 may be general-purpose computing devices (e.g., mobile phones, tablets, laptops, desktops, etc.) such as that depicted in FIG. 7. In general, sending device 222 and receiver device 212 include network interfaces enabling communication with message service 200 and include suitable software and hardware for receiving and displaying messages transmitted from message service 200. Message service 200 may be implemented as a single computing device (such as that depicted in FIG. 7) or multiple such computing devices communicating over an internal network. Specific network architectures are not limiting. As will be discussed further, sending device 222 may be configured to send messages to other users (including a user of receiver device 212). As such, sending device 222 can compose and transmit messages to message service 200 which then coordinates the delivery of the message. Conversely, receiver device 212 may be configured to access messages from message service 200 and display those messages on a display of the receiver device 212 (e.g., via a web browser or mobile application).

In some implementations, message service 200 can perform many functions to enable the receipt and delivery of messages. For example, message service 200 can implement various protocols and functionalities to support receiving, storing, and delivering email messages. Certainly, message service 200 may support other types of messages (e.g., instant messages, short message service messages, etc.) and the disclosure is not limited to email only, although email is used frequently as an example. Non-relevant implementation details to support established message protocols are not provided herein for the sake of brevity.

Message service 200 includes a messages database 202. Messages database 202 stores all messages for users that hold accounts with the message service 200. In general, message service 200 will receive messages destined for its account holders. These messages can be stored in messages database 202. Since account holders may not be online continuously, messages database 202 acts as a centralized repository of a user's messages that is persistent even though a user is not online. As such, message service 200 can process messages in messages database 202 at any time (including using the methods described herein). No limitation is placed on the implementation of messages database 202 and any suitable data storage paradigm (e.g., relational database, distributed database, etc.) may be used provided messages can be queried for and returned to, for example, content scanning module 204.

Content scanning module 204 is configured to read messages from messages database 202. In some implementations, this reading can be performed periodically, on demand, or in response to incoming messages. In one scenario, this reading is performed when a new message is received for a user. In another scenario, the message can be provided by sending device 222 prior to sending. Content scanning module 204 is configured to read a message and extract one or more objects from the message. As used herein, an object refers to a concept within a message that is represented in a viewable form (e.g., as text, image, audio, video, etc.). People, places, and things may all be represented in various viewable forms within a message. For example, a politician or celebrity may be represented via a text string of their name. In general, content scanning module 204 can scan each message to identify such objects and identify the location of the objects within a message (e.g., representable via a start position and one or more of an end position or length). In other implementations, the object can be represented by a coordinate relative to the message (e.g., to identify a location within an image).

Content scanning module 204 provides the identity and location of these objects to a message filter 206 and then to a message augmentation module 208.

In some implementations, message filter 206 may be optional. If implemented, message filter 206 can filter messages based on the objects identified by the content scanning module 204. For example, message filter 206 can retrieve a list of a user's historical feedback from feedback database 216. The user's historical feedback in feedback database 216 can be represented as a list of previous feedback values provided for objects. The feedback database 216 can store such feedback in a hierarchal or taxonomical fashion such that feedback can be provided at various levels of a hierarchy (e.g., politics, politics of certain states, specific politicians, etc.). Message filter 206 may use the detected objects provided by content scanning module 204 to query the feedback database 216 for a given user and retrieve their past feedback (if any) on these objects. If the feedback is negative (either entirely or partially), the message filter 206 may prevent the delivery of the message including such objects. Alternatively, or in conjunction with the foregoing, message filter 206 can flag the message as being likely to receive negative feedback. Such a flag may place the message in a dedicated inbox for messages containing objects associated with negative feedback.

In an implementation, message augmentation module 208 can insert explicit feedback controls within a given message based on the position of the objects identified by the content scanning module 204. For example, a message may include a portion of text and the object may indicate the start and end position of an object. In an implementation, message augmentation module 208 can insert an explicit feedback control at the end position provided by content scanning module 204. For example, the explicit feedback control may be a web component or other self-contained UI element that can be displayed inline, relative to the text. In other implementations, message augmentation module 208 can insert the explicit feedback control at or around coordinates identified by content scanning module 204.

After augmentation by message augmentation module 208 (and a lack of filtering by message filter 206, if implemented), a message delivery module 210 coordinates the delivery of the augmented message to receiver device 212. In some implementations, message delivery module 210 can comprise an application programming interface (API) or web application server that can comprise messages and message user interfaces to the receiver device 212 for display.

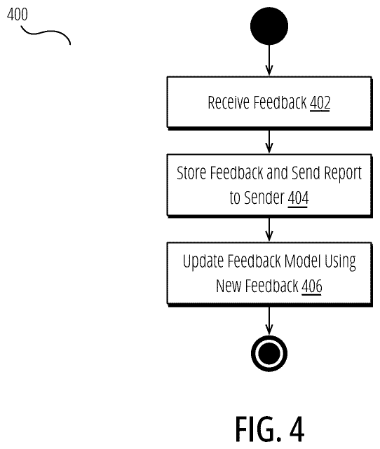

As discussed more fully in FIG. 4, a receiver device 212 can provide feedback regarding the objects detected by content scanning module 204 by interacting with the explicit feedback controls inserted by message augmentation module 208. Message service 200 includes a feedback endpoint 214 which may be implemented as a network endpoint. For example, feedback endpoint 214 may include (or be included in) a Hypertext Transfer Protocol (HTTP) server that exposes a uniform resource locator (URL) associated with a feedback update operation. In an implementation, receiver device 212 can issue an HTTP request to the feedback endpoint 214 and include the feedback value (e.g., positive or negative) as well as an identity of the object (e.g., either an identifier or the value of the object itself). In response, feedback endpoint 214 can update a record in feedback database 216 to reflect the feedback. As discussed above, feedback database 216 can store objects (or representations thereof) and a list of received feedback for each user. In one implementation, the feedback can be used to increase or decrease an integer value for each object. For example, a value for an object can be initialized to zero and then incremented for positive feedback or decremented for negative feedback. In another implementation, feedback database 216 can store counts of positive or negative feedback. In general, any system that can record an aggregated feedback value for an object may be used.

Various subsystems interact with feedback database 216 as illustrated in FIG. 2. As discussed previously, message filter 206 may use the data in feedback database 216 to filter messages that include objects having negative feedback.

A recommendation subsystem 218 can also read data from feedback database 216 to adjust the augmentation process of message augmentation module 208. Specifically, recommendation subsystem 218 can receive the objects detected by content scanning module 204 for a given message and “pre-fill” the explicit feedback controls such that the displayed message includes a “guess” of the user's feedback. Such pre-filling may take the form of visually modifying a feedback control to appear as if it was selected by the user (e.g., form filling an outline of a thumbs up).

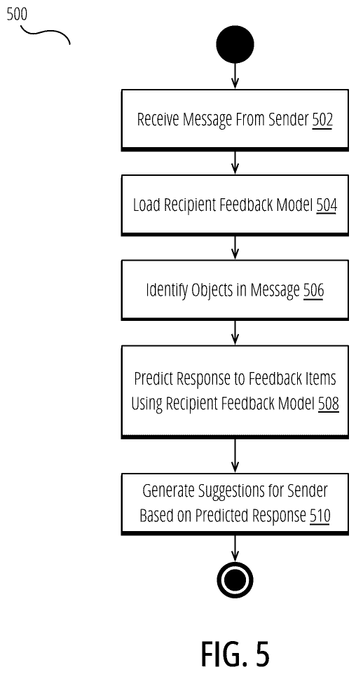

In some implementations, this guess can be provided only for objects having existing feedback. In other implementations, this guess can be extrapolated for new objects from existing feedback data of previous objects. As discussed, the feedback database 216 may store data in a hierarchy and thus recommendation subsystem 218 can extrapolate user preferences for unknown objects based on their location in the hierarchy. For example, if a user frequently provides positive feedback regarding Democrat politicians, a previously unseen politician may be deemed as likely to receive positive feedback and the explicit feedback control can be pre-filled as a positive response when displayed to the user. Details of these operations are provided in more detail in FIG. 5 and are not repeated herein.

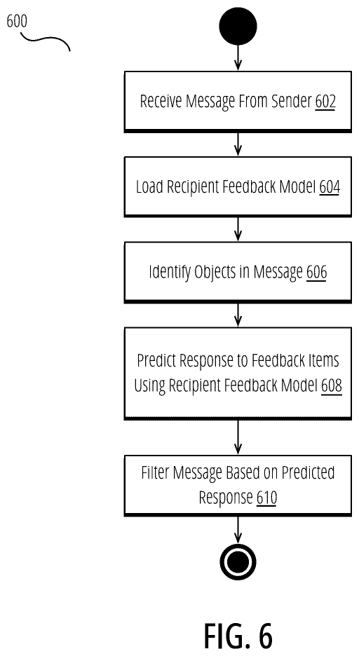

Message service 200 also includes a suggestion generator 220. The suggestion generator 220 can receive new messages from a sending device 222. Such messages may be received before being transmitted to a recipient. In response to such a message, the suggestion generator 220 can transmit the new message to the content scanning module 204 to identify objects (discussed previously). The suggestion generator 220 can then query the feedback database 216 to identify past feedback on the detected objects (or similar objects), as discussed with respect to recommendation subsystem 218. Based on the feedback stored in feedback database 216, the suggestion generator 220 can provide suggestions to the sender regarding the new message. For example, if the new message includes objects that have received negative feedback, suggestion generator 220 can flag these objects and advise the sender that such objects should be avoided. Further, in some implementations, suggestion generator 220 can generate candidate suggestions based on the feedback in feedback database 216. For example, if a user expresses a preference for shoes and a dislike of dresses, suggestion generator 220 can recommend the new message's references to dresses be replaced with shoes. Details of these operations are provided in more detail in FIG. 6 and are not repeated herein.

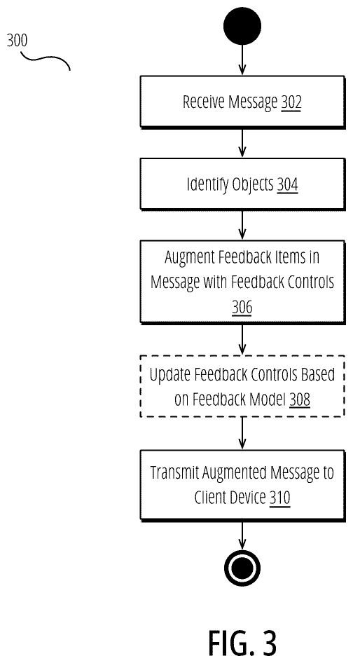

FIG. 3 is a flow diagram illustrating a method for augmenting a message with feedback controls.

In step 302, method 300 can include receiving a message. In some implementations, a message can include an email message, chat message, instant message, social network message, in-app message, or generally any other type of communication between users. In general, method 300 may receive the message over a network and may store the message for later processing.

In step 304, method 300 can include identifying one or more objects in the message.

In this step, method 300 can read a message and extract one or more objects from the message. As used herein, an object refers to a concept within a message that is represented in a viewable form (e.g., as text, image, audio, video, etc.). People, places, and things may all be represented in various viewable forms within a message. For example, a politician or celebrity may be represented via a text string of their name. In general, method 300 can scan each message to identify such objects and identify a location of the objects within a message (e.g., representable via a start position and one or more of an end position or length). In other implementations, the object can be represented by a coordinate relative to the message (e.g., to identify a location within an image).

Method 300 can process the content of the message to identify objects within the body content of messages. In one implementation, method 300 can use an NER model to extract entities (i.e., objects) within the message. In other implementations, a list of known objects can be used to extract objects from the message. As an example, an entity (person) of “John Public” can be identified from a text string in the message “John Public is in the news today . . . ” Similarly, method 300 can identify the place “Jersey City” as an object (place) from the text string in the message “The Jersey City politician was issued a summons . . . ” Certainly, more, or fewer, such entities can be identified in such a manner.

In step 306, method 300 can include inserting an explicit feedback control in the message, the explicit feedback control associated with the object.

In some implementations, a message can be formatted in a known language such as HTML. As such, an explicit feedback control can be implemented as a component in such a language. For example, the explicit feedback control can be implemented as a Web Component, React component, Vue component, or a snippet of HTML, styling (e.g., Cascading Style Sheets, CSS), and JavaScript code.

In some implementations, step 306 can include inserting the explicit feedback control into the body of the message. As discussed, each object can be associated with a position relative to the message. As such, step 306 can include inserting the explicit feedback control at the identified position. For example, a message body comprising HTML can be represented as a long string and objects can be represented as position offsets of this long string. Then, step 306 can include inserting the explicit feedback control (e.g., snippet or Web Component) into the string at the offset.

For example, a message body string can include the snippet: “<p> The Jersey City politician was issued a summons . . . </p>”. The object “Jersey City” can be represented by a start position of seven and a length of eleven (or end position of 18). Step 306 can then insert the explicit feedback control based on this position data: “<p> The Jersey City<FeedbackControl object=‘Jersey City’/> politician was issued a summons . . . </p>”. Here, the control (<FeedbackControl object=‘Jersey City’/>) is a component that facilitates the display of feedback controls and transmission of interactions (discussed herein). As illustrated, in some implementations, the feedback control can include attributes (“object=”) that encapsulate the details of the identified object to allow for identified feedback on specific entities or objects.

Alternatively, or in conjunction with the foregoing, step 306 can include associating the explicit feedback control with the entire message (depicted in FIG. 1C). In this scenario, the explicit feedback control can be indicated as metadata of the message and the UI can be configured to determine where to display the feedback control (since it may be outside of the message body, as illustrated in FIG. 1C).

In step 308, method 300 can include optionally updating the explicit feedback control based on previous feedback of the user with respect to the object, the previous feedback stored in a feedback model.

As will be discussed in more detail in FIG. 4, a user can interact with the explicit feedback control and submit feedback (e.g., positive or negative) regarding an object to a system. The system can then store mappings of objects to feedback (as discussed in FIG. 2). In step 308, method 300 can use the objects identified in step 304 to query this feedback model and determine if a user has already provided feedback on the object. In some implementations, this feedback can be represented as a binary “positive” or “negative” value. In other implementations, the feedback may be more detailed (e.g., providing a count of types of feedback). In either scenario, method 300 can analyze the received feedback and determine what the user's likely feedback would be for the object. For example, if the majority of a user's feedback for a given object is negative, method 300 can presume that the user will have more negative feedback.

As such, step 308 can include updating the explicit feedback control based on past interactions. For example, if the explicit feedback control comprises two icons (e.g., thumbs up and thumbs down) and the user's previous feedback was negative, step 308 can include styling the thumbs down icon to indicate that it is already selected (e.g., by filling in the color of the icon or otherwise emphasizing it). Further, in some implementations, step 308 can include updating the feedback model pre-emptively based on the predicted feedback. Notably, a user can still de-select the updated explicit feedback control and select a different type of feedback. In such a scenario, method 300 can change the pre-emptively updated feedback based on the actual feedback.

In step 310, method 300 can include transmitting the message to a user.

After the augmentation in step 306 and optional updating in step 306, method 300 coordinates the delivery of the augmented message to a receiver. In some implementations, method 300 can utilize an API or web application server that can comprise messages and message user interfaces to the receiver device for display.

FIG. 4 is a flow diagram illustrating a method for receiving explicit feedback for messages and processing such feedback.

In step 402, method 400 can include receiving user feedback for an object in a message.

As discussed above, a message that includes an explicit feedback control is transmitted to a user. In response, the user device displays the message including the explicit feedback control, as depicted in FIGS. 1A through 1C. In an implementation, a user interacts with the explicit feedback control by clicking, touching, or otherwise selecting the explicit feedback control. For example, if the explicit feedback control includes a thumbs up and thumbs down control, a user can select one or the other control to provide feedback on an object.

In an implementation, selection of the explicit feedback control causes the displaying client device to transmit a network message to a remote computing device (e.g., message service 200). In an implementation, the client device can issue an HTTP request including details of the interaction. In an implementation, these details can include an identifier of the object (e.g., its name or unique identifier), data representing the feedback, and optionally user-identifying data (e.g., for authentication).

In step 404, method 400 can include storing the feedback and, if implemented, sending feedback to a sender of the message.

As discussed in FIG. 2, a system can store all received user feedback. In some implementations, method 400 can update a data record that records user feedback for objects. For example, method 400 can store a mapping of objects to feedback data for each user. As one example, method 400 can store a table (e.g., in a relational database) that includes, for each row, a user identifier, object identifier and feedback data. In some implementations, method 400 can update already existing feedback records based on new feedback (e.g., incrementing or decrementing a feedback type). As discussed, in some implementations, the feedback can be stored in a binary fashion: either positive or negative. However, in other implementations, continuous values can be used (e.g., a rating between zero and ten). Further, in other implementations, the types of feedback can be tracked separately (e.g., a count of the number of positive feedback selections and a count of the number of negative feedback selections).

In some implementations, method 400 can also send a report to the sender. In some implementations, this report can be in response to the feedback. In other implementations, the report can be sent periodically after aggregating multiple feedback selections. In some implementations, the report can be an email, document, or other type of electronic format that can present statistics regarding the types of feedback received.

In step 406, method 400 can include updating a feedback model using the new feedback.

In some implementations, the database of feedback itself can be the feedback model. As such, in these implementations, step 406 can be omitted. However, in other embodiments, separate feedback models can be used to model user preferences. For example, in some implementations, a collaborative feedback model can be used to model user preferences across all users. Since the feedback comprises a user's explicit likes and dislikes, this data can be used across users to train a model that can predict whether or not a user will like or dislike future objects. As another example, a content-based filtering approach can be used where a user profile is built for each user based on their historical likes and dislikes of certain objects. Certainly, other types of predictive models can be used including neural networks, regression models, and even ensemble models combining the predictions of multiple types of models.

As illustrated, this refinement can be performed in response to each time feedback is received. In other embodiments, the refining of the model can be batched and performed at regular intervals (or when sufficient data has been received).

FIG. 5 is a flow diagram illustrating a method for using explicit feedback to provide messaging suggestions to a sender.

In step 502, method 500 can include receiving a message from a sender.

In one implementation, the message may be a message that the sender will send in the (potentially near-term) future. For example, the sender can draft the email via a UI (e.g., web interface) and the UI can periodically transmit the draft to a central system as the message received in step 502. In other implementations, the sender can send the message, and the centralized system can intercept the message and perform method 500 prior to sending the message to the recipient.

In step 504, method 500 can include loading a recipient feedback model. Details of the feedback model are provided in the foregoing description and not repeated herein. In brief, method 500 can extract a recipient identifier (e.g., email address) from the message and determine if an existing feedback model exists for the user. Such a feedback model can be generated, for example, using the method of FIG. 2 and may record a user's preferences for various objects.

In step 506, method 500 can include identifying any objects present in the message. In an implementation, step 506 can be performed in a manner identical to that described with respect to step 304 of FIG. 3 and that description is not repeated herein. In brief, method 500 can scan a draft of a message to identify objects currently present in the message prior to the message being sent.

In step 508, method 500 can include predicting a response to the one or more objects based on the recipient feedback model. Similar to step 308, method 500 can include inputting the detected objects (step 506) into the recipient feedback model and predicting the recipient's response to the objects. For example, the recipient feedback model may predict whether a user will have a positive reaction to the object or a negative reaction to an object. Reference is made to step 308 for further details of predicting a response to an object.

In step 510, method 500 can include generating suggestions for the sender based on the predicted response from step 508.

As discussed above, method 500 may operate prior to a sender transmitting a message or prior to the ultimate delivery of the message. As such, in these implementations, method 500 can predict how a user will respond to objects in a message (or, as discussed in FIG. 1C, the entire message) and then provide feedback to the sender. For example, method 500 can update the UI of the draft message with the predicted feedback for each object (e.g., highlighting negatively viewed objects in red and positively viewed objects in green). As another example, method 500 can generate a “score” for the draft of the message based on the amounts of negative and positive feedback for objects.

In some implementations, method 500 can also provide a listing of potential alternative objects for any objects associated with negative feedback. In some implementations, the system can identify a set of candidate objects that are similar to an object receiving a predicted negative response. Method 500 can then re-execute step 508 for these candidate objects to identify one or more objects predicted to receive a positive response. Method 500 can then provide a listing of subject objects to the sender to allow the sender to revise a message to include objects that would likely receive positive feedback.

FIG. 6 is a flow diagram illustrating a method for using explicit feedback to filter messages destined for a recipient.

In step 602, method 600 can include receiving a message from a sender. In an implementation, method 600 can receive messages from a sender that are addressed to a recipient. In such implementations, method 600 can process the message before a recipient can access (e.g., read) such messages. For example, method 600 can operate on messages prior to display in an inbox or similar type of aggregate view.

In step 604, method 600 can include loading a recipient feedback model. Details of the feedback model are provided in the foregoing description and not repeated herein. In brief, method 600 can extract a recipient identifier (e.g., email address) from the message and determine if an existing feedback model exists for the user. Such a feedback model can be generated, for example, using the method of FIG. 2 and may record a user's preferences for various objects.

In step 606, method 600 can include identifying any objects present in the message. In an implementation, step 606 can be performed in a manner identical to that described with respect to step 304 of FIG. 3 and that description is not repeated herein. In brief, method 600 can scan messages addressed to a user prior to storing them permanently in the user's messages.

In step 608, method 600 can include predicting a response to the one or more objects based on the recipient feedback model. Similar to step 308, method 600 can include inputting the detected objects (step 606) into the recipient feedback model and predicting the recipient's response to the objects. For example, the recipient feedback model may predict whether a user will have a positive reaction to the object or a negative reaction to an object. Reference is made to step 308 for further details of predicting a response to an object.

In step 610, method 600 can include filtering the message based on the predicted response.

In an implementation, method 600 can determine the number of objects receiving a predicted positive response and the number of objects receiving a predicted negative response. In such an implementation, if the number of objects receiving a predicted negative response exceeds the number of objects receiving a predicted positive response, method 500 may filter the message. Alternatively, method 600 may predict the response to the entire message (as in FIG. 1C) and filter the message if the predicted response is negative.

In some implementations, filtering the message may include preventing the delivery of the message to the recipient. In such an implementation, the receiving user may never receive the message. In other implementations, filtering the message may include flagging the message and displaying the flag in the UI of an aggregate view (e.g., inbox). In other implementations, filtering the message may include assigning the message to a low priority (or similar) container (e.g., inbox) to allow the user to still view the message while not displaying the message in a main container (e.g., main inbox).

FIG. 7 is a block diagram of a computing device.

In some embodiments, the computing device 700 can be used to perform the methods described above or implement the components depicted in the foregoing figures.

As illustrated, the computing device 700 includes a processor or central processing unit (CPU) such as CPU 702 in communication with a memory 704 via a bus 714. The device also includes one or more input/output (I/O) or peripheral devices 712. Examples of peripheral devices include, but are not limited to, network interfaces, audio interfaces, display devices, keypads, mice, keyboard, touch screens, illuminators, haptic interfaces, global positioning system (GPS) receivers, cameras, or other optical, thermal, or electromagnetic sensors.

In some embodiments, the CPU 702 may comprise a general-purpose CPU. The CPU 702 may comprise a single-core or multiple-core CPU. The CPU 702 may comprise a system-on-a-chip (SoC) or a similar embedded system. In some embodiments, a graphics processing unit (GPU) may be used in place of, or in combination with, a CPU 702. Memory 704 may comprise a non-transitory memory system including a dynamic random-access memory (DRAM), static random-access memory (SRAM), Flash (e.g., NAND Flash), or combinations thereof. In one embodiment, bus 714 may comprise a Peripheral Component Interconnect Express (PCIe) bus. In some embodiments, bus 714 may comprise multiple busses instead of a single bus.

Memory 704 illustrates an example of non-transitory computer storage media for the storage of information such as computer-readable instructions, data structures, program modules, or other data. Memory 704 can store a basic input/output system (BIOS) in read-only memory (ROM), such as ROM 708, for controlling the low-level operation of the device. The memory can also store an operating system in random-access memory (RAM) for controlling the operation of the device

Applications 710 may include computer-readable and computer-executable instructions which, when executed by the device, perform any of the methods (or portions of the methods) described previously in the description of the preceding Figures. In some embodiments, the software or programs implementing the method embodiments can be read from a hard disk drive (not illustrated) and temporarily stored in RAM 706 by CPU 702. CPU 702 may then read the software or data from RAM 706, process them, and store them in RAM 706 again.

The computing device 700 may optionally communicate with a base station (not shown) or directly with another computing device. One or more network interfaces in peripheral devices 712 are sometimes referred to as a transceiver, transceiving device, or network interface card (NIC).

An audio interface in peripheral devices 712 produces and receives audio signals such as the sound of a human voice. For example, an audio interface may be coupled to a speaker and microphone (not shown) to enable telecommunication with others or generate an audio acknowledgment for some action. Displays in peripheral devices 712 may comprise liquid crystal display (LCD), gas plasma, light-emitting diode (LED), or any other type of display device used with a computing device. A display may also include a touch-sensitive screen arranged to receive input from an object such as a stylus or a digit from a human hand.

A keypad in peripheral devices 712 may comprise any input device arranged to receive input from a user. An illuminator in peripheral devices 712 may provide a status indication or provide light. The device can also comprise an input/output interface in peripheral devices 712 for communication with external devices, using communication technologies, such as USB, infrared, Bluetooth™, or the like. A haptic interface in peripheral devices 712 provides tactile feedback to a user of the client device.

A GPS receiver in peripheral devices 712 can determine the physical coordinates of the device on the surface of the Earth, which typically outputs a location as latitude and longitude values. A GPS receiver can also employ other geo-positioning mechanisms, including, but not limited to, triangulation, assisted GPS (AGPS), E-OTD, CI, SAI, ETA, BSS, or the like, to further determine the physical location of the device on the surface of the Earth. In one embodiment, however, the device may communicate through other components, providing other information that may be employed to determine the physical location of the device, including, for example, a media access control (MAC) address, Internet Protocol (IP) address, or the like.

The device may include more or fewer components than those shown in FIG. 7, depending on the deployment or usage of the device. For example, a server computing device, such as a rack-mounted server, may not include audio interfaces, displays, keypads, illuminators, haptic interfaces, Global Positioning System (GPS) receivers, or cameras/sensors. Some devices may include additional components not shown, such as graphics processing unit (GPU) devices, cryptographic co-processors, artificial intelligence (AI) accelerators, or other peripheral devices.

The subject matter disclosed above may, however, be embodied in a variety of different forms and, therefore, covered or claimed subject matter is intended to be construed as not being limited to any example embodiments set forth herein; example embodiments are provided merely to be illustrative. Likewise, the claimed or covered subject matter is intended to be broadly interpreted. Among other things, for example, the subject matter may be embodied as methods, devices, components, or systems. Accordingly, embodiments may, for example, take the form of hardware, software, firmware, or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in an embodiment” as used herein does not necessarily refer to the same embodiment, and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms such as “or,” “and,” or “and/or,” as used herein may include a variety of meanings that may depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” again, can be understood to convey a singular usage or to convey a plural usage, depending at least in part upon context. In addition, the term “based on” may be understood as not necessarily intended to convey an exclusive set of factors and may, instead, allow for the existence of additional factors not necessarily expressly described, again, depending at least in part on context.

The present disclosure is described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general-purpose computer to alter its function as detailed herein, a special purpose computer, application-specific integrated circuit (ASIC), or other programmable data processing apparatus, such that the instructions, which execute via the processor of the computer or other programmable data processing apparatus, implement the functions/acts specified in the block diagrams or operational block or blocks. In some alternate implementations, the functions or acts noted in the blocks can occur in any order other than those noted in the illustrations. For example, two blocks shown in succession can, in fact, be executed substantially concurrently, or the blocks can sometimes be executed in the reverse order, depending upon the functionality or acts involved.

These computer program instructions can be provided to a processor of a general-purpose computer to alter its function to a special purpose; a special purpose computer; ASIC; or other programmable digital data processing apparatus, such that the instructions, which execute via the processor of the computer or other programmable data processing apparatus, implement the functions or acts specified in the block diagrams or operational block or blocks, thereby transforming their functionality in accordance with embodiments herein.

For the purposes of this disclosure, a computer-readable medium (or computer-readable storage medium) stores computer data, which data can include computer program code or instructions that are executable by a computer, in machine-readable form. By way of example, and not limitation, a computer-readable medium may comprise computer-readable storage media for tangible or fixed storage of data or communication media for transient interpretation of code-containing signals. Computer-readable storage media, as used herein, refers to physical or tangible storage (as opposed to signals) and includes without limitation volatile and non-volatile, removable, and non-removable media implemented in any method or technology for the tangible storage of information such as computer-readable instructions, data structures, program modules or other data. Computer-readable storage media includes, but is not limited to, RAM, ROM, EPROM, EEPROM, flash memory or other solid-state memory technology, CD-ROM, DVD, or other optical storage, magnetic cassettes, magnetic tape, magnetic disk storage, or other magnetic storage devices, or any other physical or material medium which can be used to tangibly store the desired information or data or instructions and which can be accessed by a computer or processor.

For the purposes of this disclosure, a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer-readable medium for execution by a processor. Modules may be integral to one or more servers or be loaded and executed by one or more servers. One or more modules may be grouped into an engine or an application.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than or more than all the features described herein are possible.

Functionality may also be, in whole or in part, distributed among multiple components, in manners now known or to become known. Thus, a myriad of software, hardware, and firmware combinations are possible in achieving the functions, features, interfaces, and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example to provide a complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

We claim:

1. A method comprising:
identifying, by a processor, an object included in a message addressed to a user;
inserting, by the processor, an explicit feedback control in the message, the explicit feedback control associated with the object;
transmitting, by the processor, the message including the explicit feedback control to a client device of the user; and
receiving, by the processor, feedback from the user in response to an interaction of the user with the explicit feedback control.

2. The method of claim 1, wherein the object comprises one of text, audio, video, or graphical content.

3. The method of claim 1, wherein identifying an object include in a message comprises identifying the object using a named entity recognition (NER) routine.

4. The method of claim 1, wherein the explicit feedback control comprises a positive feedback control button and a negative feedback control button.

5. The method of claim 1, further comprising updating a feedback model based on the feedback from the user, the feedback model storing preferences of the user with respect to objects identified in messages addressed to the user.

6. The method of claim 5, further comprising updating the explicit feedback control based on previous feedback of the user with respect to the object, the previous feedback stored in the feedback model.

7. The method of claim 5, further comprising:
receiving, by the processor, a second message from a sender, the second message received prior to delivery to the user;
identifying, by the processor, a second object included in the second message addressed to a user;
reading, by the processor, a user preference for the second object using the feedback model; and
providing, by the processor, at least one suggestion regarding how to edit the second message to the sender.

8. The method of claim 5, further comprising:
receiving, by the processor, a third message addressed to a user;
identifying, by the processor, a third object included in the third message;
reading, by the processor, a user preference for the third object using the feedback model; and
filtering, by the processor, the third message based on the user preference.

9. A non-transitory computer-readable storage medium for tangibly storing computer program instructions capable of being executed by a computer processor, the computer program instructions defining steps of:
identifying an object included in a message addressed to a user;
inserting an explicit feedback control in the message, the explicit feedback control associated with the object;
transmitting the message including the explicit feedback control to a client device of the user; and
receiving feedback from the user in response to an interaction of the user with the explicit feedback control.

10. The non-transitory computer-readable storage medium of claim 9, wherein identifying an object include in a message comprises identifying the object using a named entity recognition (NER) routine.

11. The non-transitory computer-readable storage medium of claim 9, wherein the explicit feedback control comprises a positive feedback control button and a negative feedback control button.

12. The non-transitory computer-readable storage medium of claim 9, the steps further comprising updating a feedback model based on the feedback from the user, the feedback model storing preferences of the user with respect to objects identified in messages addressed to the user.

13. The non-transitory computer-readable storage medium of claim 12, the steps further comprising updating the explicit feedback control based on previous feedback of the user with respect to the object, the previous feedback stored in the feedback model.

14. The non-transitory computer-readable storage medium of claim 12, the steps further comprising:
receiving a second message from a sender, the second message received prior to delivery to the user;
identifying a second object included in the second message addressed to a user;
reading a user preference for the second object using the feedback model; and
providing at least one suggestion regarding how to edit the second message to the sender.

15. The non-transitory computer-readable storage medium of claim 12, the steps further comprising:
receiving a third message addressed to a user;
identifying a third object included in the third message;
reading a user preference for the third object using the feedback model; and
filtering the third message based on the user preference.

16. A device comprising:
a processor; and
a storage medium for tangibly storing thereon logic for execution by the processor, the logic comprising instructions for:
identifying an object included in a message addressed to a user;
inserting an explicit feedback control in the message, the explicit feedback control associated with the object;
transmitting the message including the explicit feedback control to a client device of the user; and
receiving feedback from the user in response to an interaction of the user with the explicit feedback control.

17. The device of claim 16, the instructions further comprising updating a feedback model based on the feedback from the user, the feedback model storing preferences of the user with respect to objects identified in messages addressed to the user.

18. The device of claim 17, the instructions further comprising updating the explicit feedback control based on previous feedback of the user with respect to the object, the previous feedback stored in the feedback model.

19. The device of claim 17, the instructions further comprising:
receiving a second message from a sender, the second message received prior to delivery to the user;
identifying, by the processor, a second object included in the second message addressed to a user;
reading, by the processor, a user preference for the second object using the feedback model; and
providing, by the processor, at least one suggestion regarding how to edit the second message to the sender.

20. The device of claim 17, the instructions further comprising:
receiving, by the processor, a third message addressed to a user;
identifying, by the processor, a third object included in the third message;
reading, by the processor, a user preference for the third object using the feedback model; and
filtering, by the processor, the third message based on the user preference.
